(19) United States
(12) Patent Application Publication
(10) Pub. No.: US 2013/0039527 A1
(43) Pub. Date: Feb. 14, 2013

(54) MODULAR, CONFIGURABLE SPEAKER AND A METHOD OF OPERATING IT

(71) Applicants: Søren Borup Jensen, Struer (DK); Lyle Bruce Clarke, Lunderskov (DK); Jørgen Daucke von Barner, Struer (DK)

(72) Inventors: Søren Borup Jensen, Struer (DK); Lyle Bruce Clarke, Lunderskov (DK); Jørgen Daucke von Barner, Struer (DK)

(73) Assignee: Bang & Olufsen A/S, Struer (DK)

(21) Appl. No.: 13/551,193

(22) Filed: Jul. 17, 2012

(30) Foreign Application Priority Data
Aug. 8, 2011 (DK) 2011 00595

(51) Int. Cl. H04R 1/02

(52) U.S. Cl. 381/387

(57) ABSTRACT

An adaptable system for configuring an audio reproduction system comprising a main element and one or more speaker elements which may move and output moving information. A processor receives the moving information and an audio signal and generates an adapted loudspeaker signal, taking into account the movement, to the speaker elements.

### CROSS-REFERENCE TO RELATED APPLICATION

This U.S. non-provisional patent application claims the benefit of priority to Denmark Patent Application No. 201100595 filed Aug. 8, 2011, the entire disclosure of which is incorporated by reference herein.

The present invention relates to an adaptable system for configuring an audio reproduction system comprising two or more loudspeakers.

The capability of the mode of configuring includes different aspects: 1) the user selects and stacks a number of speaker elements according to his/her desire and functional requirements; 2) the system adapts to the acoustical characteristics of the environment, such that the individual loudspeaker modules are positioned relatively to each other and to the orientation in a room according to prerequisites set up by the user, and to the constraints determined by the room.

The invention relates to different transducer configurations and may provide sound as presented in surround sound systems and traditional stereophonic system, and to be applied in any domain like a home, in a car, in a boat, in an office or in any other private or public domain.

Configurations may be seen in U.S. Ser. No. 12/669,080, U.S. Ser. No. 12/531,350, U.S. Pat. No. 4,953,223, U.S.2009/0225996 and U.S. Pat. No. 3,081,602.

The speaker according to the invention may allow a user to configure and reconfigure a sound reproduction system fulfilling the demand being: extendable, adjustable over time, cost effective, individual setting of acoustical behaviours, adaptive to room characteristics and physical constraints or adaptive to user's taste and preferences.

A preferred embodiment of a speaker of the invention briefly relates to:
Allow stacking of two or more speaker modules/elements, each element comprising one or more loudspeaker(s), and optionally amplifier means, and optionally filtering circuit providing a frequency dependent amplification, and optionally gain control;
Obtain a relative location in the room per loudspeaker module; the location being characterised as: an X,Y position for the base module (the platform), this position is relative to a room location; and an X,Y,Z position of each loudspeaker modules, this position is relative to the base module location.
Allow predefined settings of the acoustical characteristics for each loudspeaker, including gain, delay and filtering; the settings relate to the X, Y, Z position and calculated angles of displacement/elevation per loudspeaker.
The user may command each speaker element to turn/move or elevate to a desired position, and save this actual set up as a predefined setting.
Apply predefined settings as modes of operation that may be entered upon receiving a given event, e.g. upon power up from stand by, a user given command or automatically based on the acoustical characteristics of the environment i.e. the listening room.

In a first aspect, the present invention relates to a speaker comprising a main element and one or more speaker elements, wherein:
each speaker element comprises:
one or more loudspeaker(s),
a loudspeaker signal input,
a movement element configured to move the speaker element in relation to at least the main element and/or another speaker element and
a movement signal output,
the main element comprises:
a speaker signal input,
a loudspeaker output,
a movement signal input, and
a processor configured to receive a signal from the speaker signal input and a signal from the movement signal input and to generate a loudspeaker signal for each individual speaker element on the basis of the signal from the signal input and a movement signal from the pertaining speaker element.

In the present context, a speaker is an element adapted to output sound on the basis of a received signal. Usually in the speaker field, the received signal will have or represent a frequency content, which is duplicated, according to, or limited by, the capabilities of the speaker. In the present context, the signal received on the speaker signal input may be an analogue signal representing the frequency contents of the desired sound to be output. This analogue signal may be carried on a carrier frequency if desired. Alternatively, the signal received may be a digital signal comprising a number of discrete values which may be converted into an analogue signal either before or after any filtering and/or amplification performed.

A loudspeaker typically is a transducer able to convert an electrical signal, such as an analogue signal, into sound. Usual loudspeakers are adapted to displace an element, such as a diaphragm, in accordance with the signal received. A loudspeaker typically is able to reproduce or output sound within a certain frequency interval, which may be wider or narrower. The highest audible frequencies usually are reproduced by a so-called tweeter, where the lowest audible frequencies and frequencies lower than that are normally reproduced by a so-called sub-woofer or a woofer. The centre or middle range is usually reproduced by a mid-range speaker. The full range may be output by a so-called full range speaker.

It may be desired that the sound desired output from the individual speaker element is identical, or different speaker elements may have different loudspeakers adapted to output sound within different frequency intervals. In one situation, a signal received on the speaker signal input is filtered and divided into signals fed to the loudspeaker output(s) and therefrom to the loudspeaker signal inputs of the speaker elements. In another situation, the same signal is fed from the loudspeaker output to all loudspeaker signal inputs, where a filtering may then be performed in each or some of the speaker elements.

In addition, amplification may be performed in the main element of the signal received on the speaker signal input and/or in the individual speaker elements.

Then, the loudspeaker signal may be a signal with the frequency contents (the audio signal) intended output from the speaker element. Alternatively, the loudspeaker signal may be a signal identifying adaptation (filtering, amplification and/or delay, or the like) to be performed in the speaker element of an audio signal received by the speaker element either from the main element or from a source feeding also the speaker signal input. In the first situation, the main element may have a filter, a delay and/or an amplifier adapting the signal before outputting from the main element. I the second situation, the filter/delay/amplifier is provided in the speaker element. Naturally, a combination may be used if desired.

The signal type received on the speaker signal input may be of the same type or a different type than the signal type forwarded from the loudspeaker output(s) to the loudspeaker signal inputs. These types may be analogue signal (potentially carried on a carrier frequency) or digital (such as a sequence of values, bits or the like). As for analogue signals, digital signals may conform to any known standard, such as the SPDIF standard, USB, USB2, USB3, Ethernet, FireWire, or the like. Naturally, the speaker signal input, the loudspeaker signal output(s) and the loudspeaker signal inputs may each be adapted to receive/transmit analogue signals or digital signals over a wire, an optical conductor or in a wireless manner, such as using wireless Wi-Fi, Bluetooth, radio waves, optical communication, or the like.

Naturally, a loudspeaker output may be provided for each loudspeaker input, or less outputs may be used each transmitting a signal to a plurality of speaker elements. In one situation, the signal output from a loudspeaker output may be fed in parallel to each of a plurality of loudspeaker signal inputs. In another situation, the loudspeaker signal inputs may be fed in a daisy-chain fashion, where the signal from the loudspeaker signal output is fed to a first loudspeaker signal input and therefrom (or a signal output of the pertaining speaker element) to the next loudspeaker element, and so forth.

Each speaker element comprises a movement element configured to move the speaker element in relation to at least the main element and/or another speaker element. In this respect, the movement may be any type of movement, such as a translation and/or a rotation. The translation preferably is in the vertical direction, but horizontal translation and/or a translation at an angle to horizontal and vertical may be used.

A rotation preferably is in the horizontal plane so that the rotation axis is vertical. Again, any rotation axis may be desired and used. Movement, translation and/or rotation about or along multiple axes may be preferred.

The movement element may comprise one or more elements or apparatus each moving/translating/rotating the speaker element, such as along or around a predetermined axis. A movement element or apparatus may be based on or actuated by a linear actuator, a stepper motor, a hydraulic element, a motor, a toothed rod and a toothed wheel, a piezo electric element, a magnet or the like.

Naturally, the movement may be, as is described below, quantified. Usually, the movement is controlled by a controller, so the usual functionalities, such as the maintaining of knowledge of a position/height/rotation or the like and the determination of a position/rotation/height may be provided. This may be performed using detectors or the like indicating a predetermined movement/height/angle, where the movement thereafter may be quantified.

Even though the movement signal may indicate merely that a movement has been performed, such as in the situation where the movement is controlled from the outside of the speaker element or is predetermined (the amount of movement is known on beforehand), preferably, the movement signal comprises more information, such as relating to a quantity or type of movement.

As is the situation in relation to the loudspeaker output, a movement signal input may be provided in the main element for each speaker element, or the connection between the movement signal input and the movement signal outputs may be of a daisy chain type or other network types where multiple signals may be received on a single input or a limited number of inputs.

The processor is configured to receive a signal from the signal input and a signal from the movement signal input and to generate a loudspeaker signal for each individual speaker element on the basis of the signal from the signal input and a movement signal from the pertaining speaker element.

Preferably, the signal for a speaker element is generated on the basis of the movement information received from the movement signal output of that speaker element. Actually, the signal may be generated also on the basis of the movement information from other of the speaker elements. This is described further below.

The processor may be software controlled, hardwired or a combination. The processor may be distributed or provided as a single element and may be based on any desired technology, such as a DSP, an ASIC, a FPGA, or the like.

The main element may itself form part of speaker element so as to have also one or more loudspeakers. In a preferred embodiment, the main element comprises a woofer and forms the basis of a speaker having one or more additional speaker elements which may be added or removed as desired. A speaker element may be configured, such as with the selection of loudspeakers, to be operable on its own, such as in a smaller room, and may be adapted to be connected to the main element to form part of a larger, more powerful speaker for use in larger rooms or in situations where the requirements to the reproduced sound are higher.

In one situation, at least one speaker element comprises a quantifier configured to quantify an amount of a movement brought about by the movement element of the speaker element and output to the movement signal output a signal representing a quantified movement. In this situation, the processor may be adapted to generate the loudspeaker signals also on the basis of the quantified movements. It is noted that the sound, at a listening position, will depend on the relative position of the speaker and the listening position as well as parameters of the room and relative angles between the loudspeaker axes and the listening position as well as output characteristics of the loudspeakers. Thus, it is desired to know the amount of movement.

It may be desired that the speaker further comprises a lower element, where the at least one speaker element rests on the lower element and the movement element being configured to move the speaker element in relation to the lower element, wherein the quantifier is adapted to quantify an amount of a movement in relation to the lower element.

In this respect, the lower element for one speaker element may be another speaker element, and the lower element for a lowest speaker element may be the main element or a support supporting the remainder of the speaker.

When the movement is a movement relative to the element on which the speaker element is supported/positioned, the speaker elements may have, in a housing thereof, its movement element which is adapted to act on the lower element. This acting may be a pushing away therefrom, which may be an elevation of the speaker element, and/or a rotation in relation to the lower element, typically in the horizontal plane.

In one situation, the movement element is configured to elevate the speaker element. This may simply be by extending or prolonging one or more support elements on which the speaker element supports itself on a lower surface.

In that or another situation, the movement element is configured to rotate the speaker element. This may be obtained by having a lower part of the movement element supporting itself on the lower element or surface and an upper part of the movement element comprising the loudspeaker(s) and being rotatable in relation to the lower part.

Alternatively, the main element and speaker elements may not be supported on each other but by a common element, such as the supporting rod as is seen in U.S. Pat. No. 4,953,223, where rotation and elevation may be performed when the rod, for example, is a toothed rod.

It is noted that when supported on each other, the overall height of a speaker element then will be affected also when a lower speaker element or the lower element changes its height. The same may be the situation with the overall angle of the speaker element, such as in relation to a listening position. Thus, the processor may comprise information relating to which speaker element is positioned on which speaker element and/or the main element and/or the lower element, so as to be able to determine an overall/combined height and/or an overall/combined angle of the speaker element for use in the generation of the loudspeaker signal for that speaker element. The overall height/angle may be determined on the basis of the movement information from all speaker elements/main element/lower element positioned below the pertaining speaker element. Additionally, the processor may desire additional information, such as a height of the individual, lower elements in order to be able to determine a combined height of a speaker element and/or a loudspeaker thereof. Additionally, the processor may desire knowledge of output characteristics of the loudspeaker(s) of the speaker element in order to, together with the angle information, determine the loudspeaker signal for the speaker element, as the angle and output characteristics are important when determining the amount of sound output toward a listening position.

Alternatively, a first speaker element may be able to forward movement information to another speaker element supported on the first speaker element, so that the movement performed by the first speaker element (elevation/rotation for example) may be counter-acted by the other speaker element, so that the other speaker element maintains its position independently of the movement of the first speaker element. Thus, when the first speaker element elevates X mm, the other speaker element may lower itself the same amount to maintain its position in space.

This controlling may be performed by the controller or a movement controller which may be provided in the main element or may be distributed in the speaker elements if desired.

In one situation, each speaker element has a parameter element configured to feed information relating to parameters of the loudspeaker(s) of the speaker element to the processor, the processor being configured to generate the loudspeaker signals also on the basis of also on received information relating to parameters of the loudspeaker(s) of the speaker elements. These parameters may be output characteristics, such as a shape or angle of the sound emission cone of the loudspeaker and/or the frequency interval in which the loudspeaker is able to reproduce sound (tweeter, mid-range, woofer, full range, mid-to-upper range or the like), as well as potentially information relating to the efficiency of the loudspeaker at different frequencies, such as the sound intensity output at a predetermined signal input at different frequencies.

These parameters may also relate to an overall height of the speaker element and an initial rotation or the like, for the processor to determine, using perhaps also the movement information of that and potentially other speaker elements, a position and an angle of the speaker element or its loudspeaker(s).

The operation of the processor in generating the loudspeaker signals may be the controlling of one or more filters and/or amplifiers.

In one situation, a separate filter is provided for each speaker element. Then, the signal for the speaker element may be generated by providing the signal received on the speaker signal input to this filter. The controlling of this filter is then obtained on the basis of the movement signal from the speaker element and potentially other speaker elements.

Also, a separate amplifier may be provided for each speaker element. This amplifier may be provided in the main element or in the speaker element. In the situation where the speaker element is also desired used outside the speaker, such as a stand-alone speaker, a built-in amplifier may be desirable.

In a preferred embodiment, the processor will generate the loudspeaker signals so that the sound at a listening position will be suitable.

Due to the direction characteristics of loudspeakers, the relative positions and directions of the loudspeakers and the listening position, as well as potentially other information, such as positions of walls, ceilings, floors etc. of a room in which the listening position and speaker(s) is/are in, may be used.

This type of information may be determined directly or indirectly. In one situation, the speaker comprises a microphone, where the processor is configured to have a loudspeaker of the speaker output a sound and have the microphone detect sound, where the processor may therefrom determine parameters of the room from e.g. reflections and the like determinable from the received/detected sound.

The listening position may be determined in a number of manners. In one situation, the listening position is determined by entering corresponding data into the processor. In another situation, a wireless or portable element is used for outputting a signal, where the speaker further comprises a detector for determining a position of the source of the wireless signal, the processor being adapted to generate the loudspeaker signal(s) also on the basis of the position.

The signal may be a Wi-Fi signal, a Bluetooth signal or a cell phone signal. Also, other types of signals, such as optical signals or acoustical signals, may be used. The direction toward the position, as well as the distance thereto, may then be determined.

Alternatively or in addition, the portable element may comprise a positioning means, such as a GPS or an element providing the position on the basis of a cell phone signal, and this position may be forwarded to the speaker in the wireless signal. The speaker in that situation may also have a positioning element in order to be able to determine the relative positions between the speaker and the position.

Naturally, the listening position may be a position in the horizontal plane only, but preferably this is determined in three dimensions.

In another situation, the listening position may be determined by positioning a microphone in the desired position and correlating sound output by the speaker with that determined by the microphone.

Naturally, the portable element, which may be a remote control, a cell phone, a laptop computer, a tablet PC, a remote control, or the like, may be used for also controlling other features of the speaker, such as the sound output (volume, filtering), the sound source (radio channel, media library, or the like), the sound file (selecting a file from a library, streaming a file from the Internet, selecting a radio channel or the like).

Also, the movement of the speaker elements may be controlled by the portable element, such as by individually controlling an element or by defining relative movements or final positions of the speaker elements and controlling the speaker elements to move to such positions. In one situation, multiple such positions, such as a position for a particular listening position while seated, a good listening position while standing, a position for good sound in the whole room (multiple listeners, when cleaning, or the like), a compact or inactive position, may be defined, and the user may select any of these positions, where after the individual speaker elements are instructed to move to its pertaining position.

The processor may determine a filtering and amplification, as well as a delay, to be provided to each speaker element. This determination may be performed only when changes are seen, such as a movement of a speaker element, an addition/removal of a speaker element, a change in the listening position and/or a change in listener's preferences (sound volume, filtering or the like). Alternatively, the processor may continuously or intermittently determine such data and perform any updating required to generate the correct loudspeaker signals.

It is noted that the signal connections between the speaker element(s) and the main element may be wireless or wired and using any protocol and cable type. In one situation, the movement element has a part supporting, or taking part in the supporting, the speaker element on a lower element. In this situation, this part may comprise a plug, as may the speaker elements at their upper sides, so that communication between the speaker element(s) and the main element may be performed via these parts and plugs. In this manner, no cables are required. Cables tend to cause structures to look messy and generally may be desired avoided.

A second aspect of the invention relates to a method of operating a speaker, such as the speaker according to the first aspect, comprising a main element and one or more speaker elements each comprising one or more loudspeakers, wherein:
a movement element of at least one of the speaker elements moves the speaker element in relation to at least the main element and/or another speaker element and outputs a movement signal,
a processor receives the movement signal and a loudspeaker signal and outputs to the speaker elements speaker signals based on the loudspeaker signal and the movement signal,
the loudspeakers of the speaker elements receive the speaker signals and output corresponding sound.

As mentioned above, the movement may be any type of movement, such as a linear movement, a movement along a curve, a rotation or a combination thereof. The movement element may be provided at least partly within a housing of the speaker element.

The movement signal may be a signal that a movement has taken place, such as a predetermined movement. In one situation, the movement step comprises quantifying the movement and wherein the movement signal represents the quantified movement.

The processor may additionally control or order the movement of the speaker elements. The processor may be software controlled, hardwired or a combination thereof and may be monolithic or distributed. Each speaker element may have its own processor for providing the loudspeaker signal. This distributed processor may comprise information from other controls in other speaker elements so as to know its position (height and rotation) when this depends on the position of other speaker elements (such as elements on which the pertaining speaker element rests).

In one situation, the movement step comprises moving the speaker element in relation to a lower element on which the speaker element rests, and wherein the movement signal represents an amount of a movement of the speaker element in relation to the lower element. As mentioned above, this lower element may be another speaker element, a support, or the main element, which may also function as a speaker element, i.e. having one or more loudspeakers.

In one situation, the method further comprises the step of each speaker element feeding to the processor information relating to parameters of the loudspeaker(s) of the speaker element, and wherein the step of the processor outputting the signals comprises the processor outputting signals generated also on the basis of received information relating to parameters of the loudspeaker(s) of the speaker elements. These parameters may be output characteristics (dimensions of output cone, for example) of the loudspeakers or the frequency characteristics thereof, so that the processor may take this into account when generating the signals.

In one embodiment, the step of the movement element moving the speaker element comprises the movement element elevating the speaker element. In that or another embodiment, the step of the movement element moving the speaker element comprises the movement element rotating the speaker element, preferably in the horizontal plane.

In a final embodiment, the method further comprises the step of determining a position of a source of a wireless signal, wherein the step of the processor outputting the signals comprises the processor outputting signals generated also on the basis of the position.

This wireless signal may be output from a portable element, such as a cell phone, a tablet PC, a remote control or a laptop computer, and the signal may be a Wi-Fi signal, a Bluetooth signal, an optical signal, an audio signal or the like. The position may be determined from a direction of the signal, seen from the speaker, and a distance to the source or the position may be determined within the portable element, such as from a built-in GPS, by triangulation or the like, and this position may be fed to the speaker in the wireless signal. The speaker may then also have a position determining element, such as a GPS or a triangulation element adapted to determine its position from e.g. cell phone signals and cell phone antenna positions.

In a preferred embodiment, a constraint table defines the configured speaker, the configuring strategy and the operators to apply accordingly. It is a great advantage to have a table to define and control the configuring procedure.

The table is a data set that represents the one or more specific speaker elements and is represented in the tables:
One first table mapping main element settings versus physical location:
[main element pos(x,y) −> select [filter (p), gain (p), delay (p)] for main element loudspeakers.
one second table mapping different modes of operation versus direction of speaker elements, e.g. Model: “play to listener position”:
Model −> main element pos (set x,y) and per speaker element loudspeaker (set angle) and set (height).
one third table mapping speaker element values for each angle and elevate options:
[main element pos(x,y) and angle speaker element (alfa) −> select [filter (q), gain (q), delay (q)] for the speaker element loudspeaker(s);
this repeated for each of the one or more speaker elements.
[main element pos(x,y) and height loudspeaker(z) −> select [filter (r), gain(r), delay(r)] for speaker element loudspeakers;
this repeated for each of the one or more speaker elements.

In the following, preferred embodiments of the invention will be described with reference to the drawing, wherein:

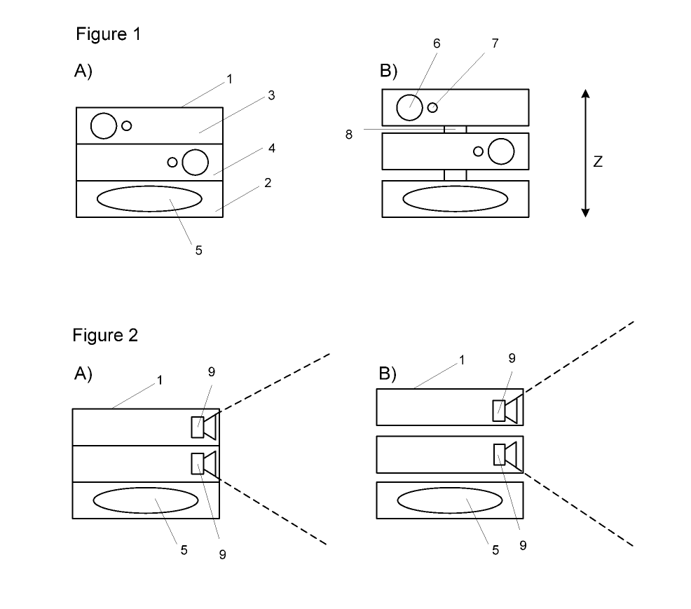

FIGS. 1A and 1B display examples of speaker element configurations;

FIGS. 2A and 2B display examples of vertical sound dispersion in an embodiment of the invention;

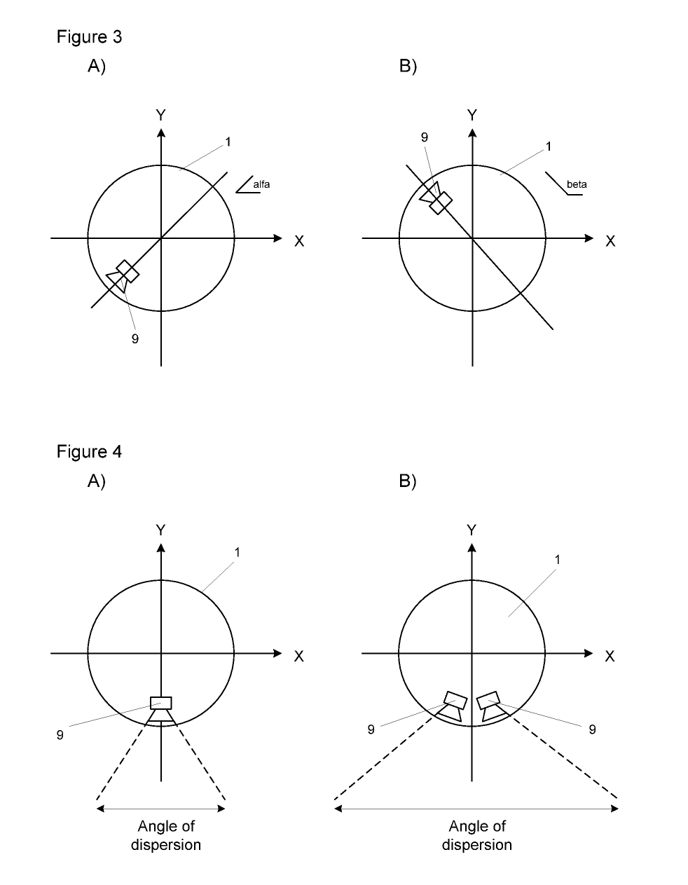

FIGS. 3A and 3B display examples of one loudspeaker in different positions in an embodiment of the invention;

FIGS. 4A and 4B display examples of sound dispersion horizontally in an embodiment of the invention;

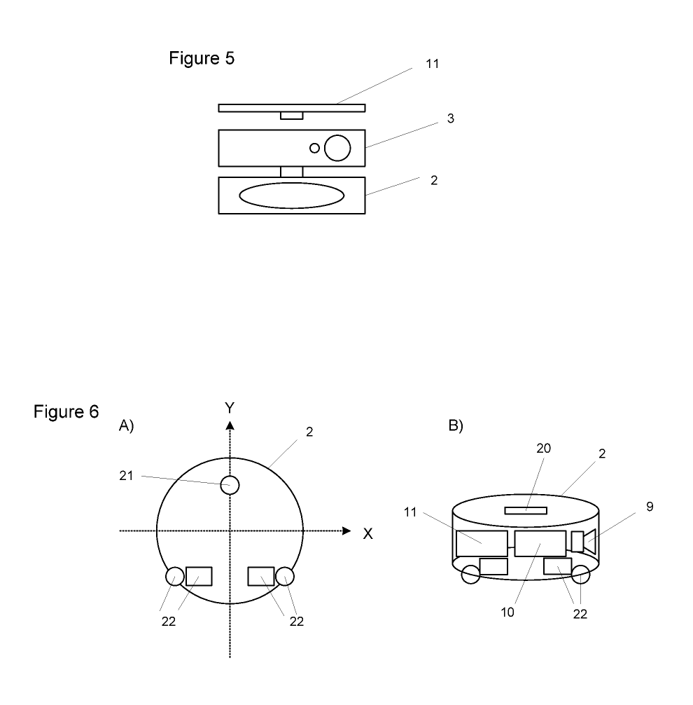

FIG. 5 displays the concept of a top plate;

FIGS. 6A and 6B display the concept of a base module;

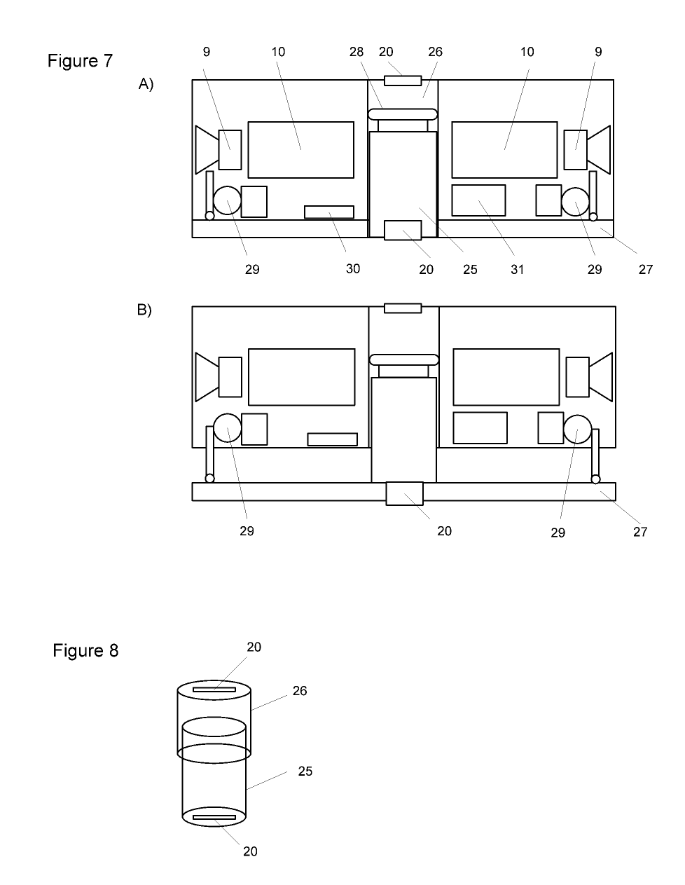

FIGS. 7A and 7B display the concept of the speaker element, in two different heights;

FIG. 8 displays a first system connector and elevation principle;

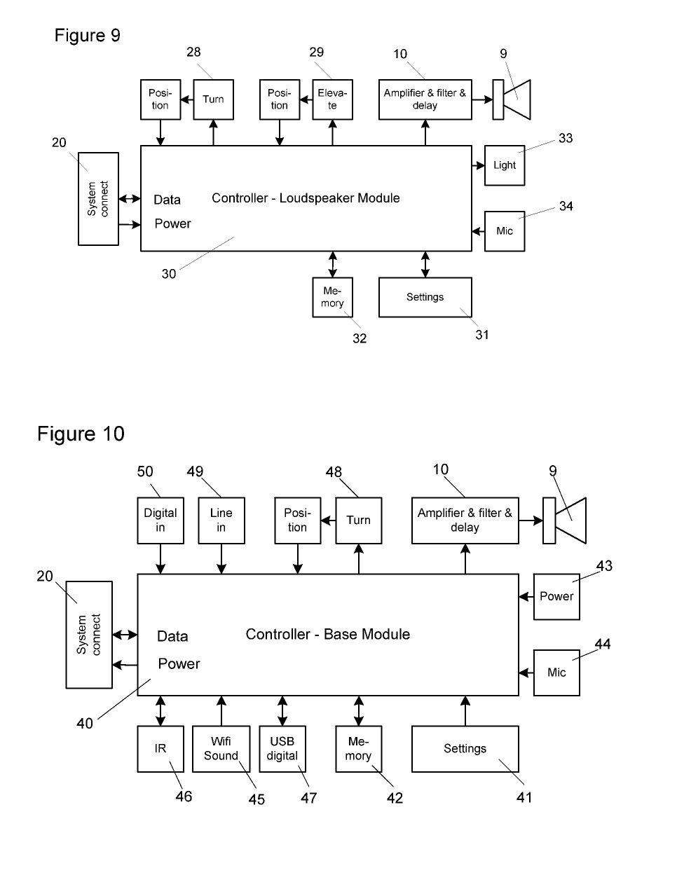

FIGS. 9 and 10 display system block diagrams of one embodiment of the invention;

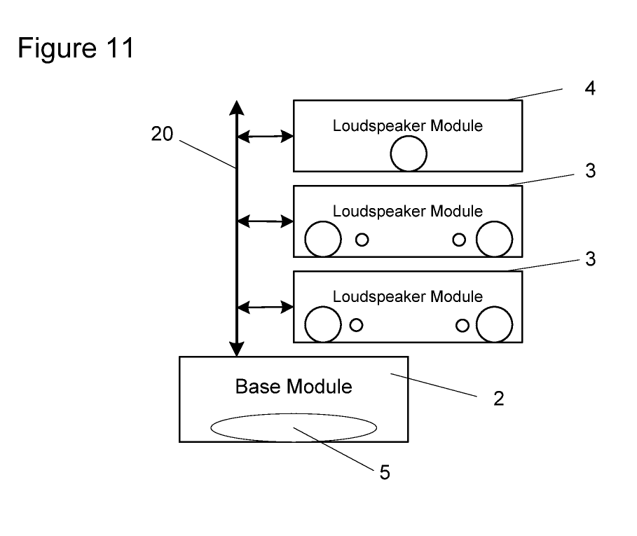

FIG. 11 displays a system connection diagram of one embodiment of the invention.

FIG. 1 illustrates components that constitute examples of speaker element configurations (1)—also called a sound system.

The illustrated system comprises a base module or main element (2) including a subwoofer (5) and two speaker elements (3, 4) each including one midrange transducer (6) and one tweeter transducer (7).

The sound system is displayed in two different configurations where the speaker elements are close to each other (A) and elevated from each other (B). In the elevated position an enhanced sound dispersion is obtained as shown on FIG. 2-B, compared to the non-elevated position in FIG. 2-A.

A loudspeaker (9) may be of any type i.e. a subwoofer/bass/low frequency (5), a midrange (6) or a tweeter/high frequency (7), and in any combination as required, and is the fundamental means that transforms the electrical signal to the sound waves produced by movements of the membrane of the loudspeaker or transducer unit.

Any standard transducer unit may be applied. The one or more speaker elements may individually be equipped with one or more of every type of transducer as demanded according to functional requirements.

In an audio reproduction system comprising active sound transducers an amplifier (10) is provided for each transducer unit (9). This type of amplifier is e.g. based on the ICEpower technology from Bang & Olufsen D K.

The transducer unit (9) and the amplifier (10) may constitute an integrated loudspeaker unit, which may be characterized as a unit having attributes for gain and frequency response. Thus the configuring procedure may operate on attributes associated with the transducer unit or loudspeaker itself, or it may operate on attributes associated with the loudspeaker unit including the transducer unit and the amplifier.

In a high quality audio reproduction system, a dedicated filter means (10) is provided per amplifier. These means provide a frequency dependent amplification to control the overall gain, which may be regulated up or down as required. Means for down regulation may be as simple as adjustment of a resistive means serial connected to the speaker element.

The outer geometrical form of the speaker element may have any form, e.g. but not limited to a circle, an ellipse, a square, a triangle, a pentagon and a hexagon; the form is determined by acoustical requirements and the industrial design shape.

FIG. 3 displays a top view of one circular speaker element (1), and indicates the speaker element be turned into two different angles (alfa, beta), bringing the loudspeaker transducer to emit the sound into two different directions. One direction (FIG. 3-A) may be to play against the wall and another direction (FIG. 3-B) may be to play against the listening position.

FIG. 4 displays a top view of two circular speaker elements (1) stacked on top of each other.

FIG. 4-A illustrates that the two modules (1) are positioned such that both loudspeaker transducers (9) are pointed in the same direction and with the same angle of sound dispersion.

FIG. 4-B illustrates that the two layered modules (1) have been turned slightly in each direction and positioned such that both loudspeaker transducers (9) are pointed in different directions, such that an enhanced angle of the horizontal sound dispersion is obtained.

FIG. 5 illustrates how a top plate (11) may constitute the upper surface of the stacked components e.g. on top of a base module (2) and a speaker element (3). A simplified connector adapts to the system connector via mechanical means without any electronics.

FIG. 6 displays a top view (A) and a skeleton side view (B) of a circular base module (2). Included are standard means that enable the base module to move and/or turn. In a preferred embodiment a point of rotation (21) makes it possible to turn the base module, around this point, via motors and wheels and to determine the angle position via sensors and control means (22). The point of rotation (21) may be a simple fixed pin, a ball or alike.

A system connector (20) is a common interface object among the stacked modules/elements. It includes a connector and cabling with a system bus for data, control signals, audio signals and power (11).

FIG. 6-B illustrates in addition a subwoofer (9) with amplifier and filter means (10) included.

FIG. 7 displays conceptual objects in a preferred embodiment of the invention.

Two modes of operation are illustrated for a speaker element: A) in which the module is in a first position, which is a default position for initial providing of sound from that module; B) in which the module is in a second position, where the module is elevated, this to act as a position for providing of sound from that module, to obtain a certain directivity as commanded by the user; in addition this second position may be the action triggered by the result of an evaluation of the acoustical characteristics of the room/environment.

Standard means are applied in the elevation arrangement (29), this comprises a motor, toothed wheels as gearing, and an arm including a ball/wheel as a bearing at the end to allow turning of the speaker element whether it is elevated or not.

Another motor, gearbox and rubber wheel (28) is attached to the fixed part of the tube (25) and supports the rotation of the module by applying a turning moment at the inner cylinder of the moveable tube (26).

Alternative mechanical means may be applied for the turning and elevation of the module, this being wire driven, moveable arms, rotating spindles and alike.

The loudspeaker transducer units (9) are equipped with amplifier, gain control and filter means (10) and control means (30) and storage/memory means (31) are included. The module is connected to other modules via the system connector (20), which supports the necessary electrical cabling and mechanical connection.

FIG. 8 displays the standard means applied in the elevation arrangement. A tube (25) is the fixed part and attached to the speaker element chassis (27). The movable part (26) can turn and elevate relative to the fixed module (25).

The system connector (20) is the mechanical and electrical interface among the speaker elements.

FIG. 9 displays a block diagram for the speaker element (3).

A controller (30) being a microprocessor and/or a digital signal processor has the interface to the other modules via the system connector (20); this to act as systems bus with power supply from the base module and to receive/exchange audio signal, data and control with other modules.

User predefined settings and system deduced parameters related to acoustical attributes and room characteristics are stored as parameters in the memory (32) and organized as settings (31) per transducer unit.

A microphone (34) supports: a) the acoustical analysis of the environment and decay of acoustical energy, such as decay time and reverberation time, (as a function of frequency); this to adjust the timbre in a part of a room; and b) estimating the physical position of a sound emitting transducers in a room.

According to the measured characteristic and the position of the sound transducer (9) the amplifier and filter settings (10) may be adjusted. Included in the calculation of the adjustment to take place is the information about the angle information obtained from the position sensors (28, 29).

Optionally a light source (33) may partly or fully illuminate a speaker element, e.g. activate a light source embedded in the spaced room between two elevated modules.

Optionally a speaker element (3) may be equipped with means to power (43) the module, either via power cabling or via batteries/accumulator and means to receive wireless sound via Wi-Fi (45) and means for wireless control (46).

These features enable the module (3) to act as a standalone loudspeaker system detached from the base station (5). The module (3) may be detached and used as a stand-alone speaker elsewhere, whereby the filtering of the other module will be different, as it now, in this set-up, is the only module providing mid-range and tweeter sound.

It is noted that different set-ups may be used where, in one set-up, the signal for the loudspeakers (9) is generated in the base module (2). In another set-up, the audio signal received by the base module (2) is fed also to the modules (3) and (4) together with information as to how to adapt this signal (filter, delay, amplify etc.), where this adaptation is performed in the module (3) or (4). Alternatively, a part of the signal adaptation may be performed in the base module (2) and the partly adapted signal fed to the module (3) and (4) together with information describing the further adaptation, which is then performed in the modules (3) and (4). It may be desired to have elements for filtering, amplifying and/or delaying in the elements (3) and (4), as this functionality may also be desired when these modules are used as stand-alone elements.

FIG. 10 displays a block diagram for the base module (2).

A controller (40) being a microprocessor and/or a digital signal processor has the interface to the other modules via the system connector (20); this to act as system bus with power supply from the base module and receive/exchange audio signal, data and control with other modules.

User predefined settings and system deduced parameters related to acoustical attributes and room characteristics are stored as parameters in the memory (42) and organized as settings (41) per transducer unit.

A microphone (44) supports: a) the acoustical analysis of the environment and decay of acoustical energy, such as decay time and reverberation time, (as a function of frequency); this to adjust the timbre in a part of a room; and b) estimating the physical position of a sound emitting transducers in a room.

According to the measured characteristic and the position of the sound transducer (9) the amplifier and filter settings (10) may be adjusted. Included in the calculation of the adjustment to take place is the information about the angle information obtained from the position sensor (48).

External connectors interface to external sources of information i.e. data and signals. In the preferred embodiment the loudspeaker system may be connected to audio/video equipment like Audio system, Video system, Smart Phone, PC, laptop, tablet computer and alike.

Thus the audio sources of information to handle are e.g. but not limited to: audio line signal (49), audio digital signal, e.g. SPDIF (50), wireless sound e.g. via Wi-Fi, or a physical connection via an USB interface (47).

Via the USB connector, stored settings may be read, modified or written/stored in a PC/laptop.

The loudspeaker system may be operated via a wireless remoter commander, supported via IR, RF or other standard technologies for remote control.

A power supply (43) delivers the necessary power for all modules that constitutes the system.

FIG. 11 displays the module connection principles in one embodiment of the invention.

A sound system configuration includes a base module (2), and three speaker elements (3, 4). Each of the three speaker elements may be equipped with different number of loudspeaker transducers, e.g.:
The base module includes one subwoofer and amplifier and filter.
The speaker element (3) includes two identical sets of transducers, each consisting of one midrange and one tweeter and amplifier and filter.
The speaker element (4) includes one midrange transducer and amplifier and filter.

The electrical connection is via the system connector (20), which constitutes a system bus including data, control signals, audio signals and power supply.

### EMBODIMENTS OF THE INVENTION

In a first embodiment of the invention a modular speaker is configured by stacking individual system/speaker elements including two or more sound transducers/loudspeakers on top of a platform module, the individual system modules comprising:
A first object to act as a platform for one or more other attached objects,
A second object to be attached to the first object via a first system connector,
A third object may be attached to the second object via a first system connector,
One or more objects of either a first object type or a second object type may be attached on top of the stacked modules,
A fourth object may be attached as a last module of the stacked modules.

### Another Embodiment of the Invention is:

A system where the first object at least includes fully or partly the functional means: power supply, system controller, memory, signal processor, data communication and data transmission, support elements including motor and wheels, a first system connector, audio sound connector, data connector, a subwoofer including amplifier and filters, a microphone.
A system where the second object and third object at least include fully or partly the functional means: a first system connector, position—and elevation control means including motor and wheels, sound provider elements including sound transducers, amplifiers, gain control and filters, a microphone.
A system, where the fourth object includes a top surface cover and means to adapt to a first system connector.

A third embodiment of the invention is that the speaker elements may rotate to change the angle of sound dispersion from each element:
A system where the first object can rotate around a predefined point on an axis aligned vertically relative to the horizontal plane of the first object.
A system where the second object and the third object can rotate around a predefined point on an axis aligned vertically relative to the horizontal plane of the first object.
A system where the one or more other objects can rotate around a predefined point on an axis aligned vertically relative to the horizontal plane of the first object.

A fourth embodiment of the invention is that the speaker elements may elevate to change the angle of sound dispersion from each speaker element:
A system where the second object and the third object may elevate along an axis aligned vertically relative to the horizontal plane of the first object.
A system where the one or more other objects may elevate along an axis aligned vertically relative to the horizontal plane of the first object.

A fifth embodiment of the invention is that the acoustical performances of the speaker elements adapt to user requested and/or environmental e.g. room characteristics, physical specifications and positions of a speaker element in a room:
A system where adaptive means adjust the acoustical parameter settings according to the angle of rotation for each of the first object, the second object, the third object and the one or more other objects.
A system where adaptive means adjust the acoustical parameter settings according to the height of elevation for each of the second object, the third object and the one or more other objects.
A system where user preferred acoustical settings may be stored and applied as actual settings on request, the preferred acoustical settings to include different modes of sound providing in a play mode including: 1) primarily against a wall, 2) primarily against a room, 3) primarily against a listener position.
A system where user preferred acoustical settings may be stored and applied as actual settings on request, the preferred acoustical settings to include different individual settings of the physical position/angle/height for each of the one or more stacked elements.

The configuring of the acoustical settings is automatically executed and/or controlled by the audio amplifier means that drives the speaker elements.

It's a coordinated effort supported by processor means in the base module and processor means in each of the stacked speaker elements.

Basically the configuring to take place is based upon the measured facts:
The physical position of the main element in the room identified as an X, Y position;
The angle that the main element is turned in the horizontal plane; this gives an offset to the X, Y position of the main element;
the angle that each of the speaker elements is turned in the horizontal plane, this gives an offset to the X, Y position relative to the main element;
the elevation that each of the speaker elements is lifted in the vertical plane, this gives an offset to the Z position relative to the main element;

The configuring means is embedded into an audio reproduction system.

Thus the system becomes the controller of the configuring process that provides a configuration of the system itself; thus it executes in an adaptive mode of operation.

The saved attributes and key parameters may be loaded and accessed, modified and reloaded into the configuring means supported by electronically means, means that are connected wirelessly or connected wired to the audio reproduction system.

The saved attributes may be saved on any type of digital media e.g. a server, SD card, PROM, EPROM, SRAM, or USB memory stick and alike.

1. A speaker comprising a main element and one or more speaker elements, wherein:
each speaker element comprises:
one or more loudspeaker(s),
a loudspeaker signal input,
a movement element configured to move the speaker element in relation to at least the main element and/or another speaker element and
a movement signal output,
the main element comprises:
a speaker signal input,
a loudspeaker output,
a movement signal input, and
a processor configured to receive a signal from the speaker signal input and a signal from the movement signal input and to generate a loudspeaker signal for each individual speaker element on the basis of the signal from the signal input and a movement signal from the pertaining speaker element.

2. A speaker according to claim 1, wherein at least one speaker element comprises a quantifier configured to quantify an amount of a movement brought about by the movement element of the speaker element and output to the movement signal output a signal representing a quantified movement.

3. A speaker according to claim 2, further comprising a lower element, the at least one speaker element resting on the lower element and the movement element being configured to move the speaker element in relation to the lower element, wherein the quantifier is adapted to quantify an amount of a movement in relation to the lower element.

4. A speaker according to claim 1, wherein each speaker element has a parameter element configured to feed information relating to parameters of the loudspeaker(s) of the speaker element to the processor, the processor being configured to generate the loudspeaker signals also on the basis of also on received information relating to parameters of the loudspeaker(s) of the speaker elements.

5. A speaker according to claim 1, wherein the movement element is configured to elevate the speaker element.

6. A speaker according to claim 1, wherein the movement element is configured to rotate the speaker element.

7. A speaker according to claim 1, further comprising a detector for determining a position of a source of a wireless signal, the processor being adapted to generate the loudspeaker signal(s) also on the basis of the position.

8. A method of operating a speaker comprising a main element and one or more speaker elements each comprising one or more loudspeakers, wherein:
a movement element of at least one of the speaker elements moves the speaker element in relation to at least the main element and/or another speaker element and outputs a movement signal,
a processor receives the movement signal and a loudspeaker signal and outputs to the speaker elements speaker signals based on the loudspeaker signal and the movement signal,
the loudspeakers of the speaker elements receive the speaker signals and output corresponding sound.

9. A method according to claim 8, wherein the movement step comprises quantifying the movement and wherein the movement signal represents the quantified movement.

10. A method according to claim 9, wherein the movement step comprises moving the speaker element in relation to a lower element on which the speaker element rests, and wherein the movement signal represents an amount of a movement of the speaker element in relation to the lower element.

11. A method according to claim 9, further comprising the step of each speaker element feeding to the processor information relating to parameters of the loudspeaker(s) of the speaker element, and wherein the step of the processor outputting the signals comprises the processor outputting signals generated also on the basis of received information relating to parameters of the loudspeaker(s) of the speaker elements.

12. A method according to claim 9, wherein the step of the movement element moving the speaker element comprises the movement element elevating the speaker element.

13. A method according to claim 9, wherein the step of the movement element moving the speaker element comprises the movement element rotating the speaker element.

14. A method according to claim 9, further comprising the step of determining a position of a source of a wireless signal, and wherein the step of the processor outputting the signals comprises the processor outputting signals generated also on the basis of the position.
